(19) United States
(12) Patent Application Publication
(10) Pub. No.: US 2006/0138103 A1
(43) Pub. Date: Jun. 29, 2006

(54) Method and system for production of laser-induced color images which change characteristics during observation

(76) Inventors: Igor Troitski, Henderson, NV (US); Andrey Shanturin, Moscow (RU); Alexander Moroshkin, Moscow (RU)

Correspondence Address: IGOR TROITSKI, 853 ARROWHEAD TRAIL, HENDERSON, NV, 89015, US

(21) Appl. No.: 11/023,115

(22) Filed: Dec. 28, 2004

(51) Int. Cl. B23K 26/067

(52) U.S. Cl. 219/121.69; 219/121.68

(57) ABSTRACT

The present invention discloses a method and a system for production of laser-induced color images which are able to change their characteristics during observation. In particular, they can change brightness, hue and saturation of color for the whole image and for its separate fragments. These effects are provided by special processing of the color image and by the transformation of the image into superposition of several primary color images and its fragments. These primary color images and their primary color fragments are transformed into arrangements of points, at which laser-induced marks are produced. Special location of laser-induced damages inside a transparent material and controlled illumination of these damages provide creation of laser-induced color images with changeable characteristics.

### FIELD OF THE INVENTION

The present invention relates to methods for producing laser-induced color images inside transparent materials by using pulsed laser radiation.

### BACKGROUND OF THE INVENTION

A number of techniques for creation of colored images on surfaces and inside transparent substrates by using natural light radiation and pulsed laser radiation are well known.

U.S. Pat. No. 4,092,139 to Ference discloses a process for making colored photosensitive glass via the exposure thereof to high energy or actinic radiation followed by heat treatment thereof. The preferred embodiment of the method contemplates exposing the nucleated glass to high energy or actinic radiation while the glass is at an elevated temperature. Thus, the nuclead glass is developed while being exposed at a temperature between about 200. degree.-410. degree C.

U.S. Pat. No. 4,295,872 to Luers discloses a method of producing an image of an original multi-color subject in polychromatic glass by employing as a masking means, during initial exposure of the glass, high contrast film positives embodying the subject in the form of half tone transparencies.

U.S. Pat. No. 4,302,235 to Luers discloses a method of producing an image of an original multi-color subject in polychromatic glass by employing, as mask during initial exposure of the glass, a continuous tone, ultra-violet transmitting, film negative in which each color in the original subject is recorded in terms of a unique film density corresponding to that color in the glass and capable of conditioning the glass for development of such color by transmission of a single predetermined exposure flux.

U.S. Pat. No. 4,328,299 to Beall, et al. discloses polychromatic glass articles and methods of producing such articles in which the glass is activated by exposure to ultraviolet radiation and contains as a sensitizing agent an oxide of copper, samarium, terbium, praseodymium, or europium. U.S. Pat. No. 4,514,053 to Borrelli, et al. discloses an integral optical device that is composed of a photosensitive glass having an optical pattern developed therein by a refractive index change due to formation of colloidal metal particles and/or crystalline microphases nucleated by such particles. In a specific embodiment the pattern is composed of at least one transparent lens system having a radial gradient refractive index distribution of prescribed nature.

U.S. Pat. No. 5,019,538 to Borrelli, et al. discloses a method of production of photosensitive opal lasses which, through an exposure to ultraviolet radiation, followed by a three-step heat treatment, and then a re-exposure to ultraviolet radiation at an elevated temperature, can be converted into a colored opal glass.

U.S. Pat. No. 6,399,914 to Troitski discloses methods and an apparatus for creating colored laser-induced damage images are produced inside transparent materials containing color impurities. Laser radiation is focused inside the transparent material in such a way that focal area contains at least one said impurity.

U.S. Pat. No. 6,566,626 to Gaissinsky, et al. discloses a method and apparatus for generating colored image of at least one color within a light-sensitive glass sample. The glass sample contains light-sensitive chemical components that acquire at least one of a multiplicity of colors in response to actinic radiation and subsequent heating to a temperature that causes color to appear. The method comprises focusing a pulsed laser beam to a target location within the glass, irradiating a plurality of pulses focused in the target location within the glass sample, thus generating a zone of increased opacity to the visible light at the target location and a resultant location actinic radiation at that zone, displacing the focus point of the laser beam and the glass sample relative to each other by the displacing device in a predetermined manner so as to produce a plurality of zone of increased opacity that form an image, and heating of the sample to a temperature that causes color to appear at the zone of increased opacity.

U.S. Pat. No. 6,664,501 to Troitski discloses a method for creating laser-induced color images within three-dimensional transparent media, particularly inside the photosensitive glass. The latent image is created by focusing of IK ultra short laser pulsed radiation into separate areas of the photosensitive glass, so as focal spot sizes are approximately equal to the resolution element of the created image. The latent image is developed to the visible image by focusing of laser pulses at points of the latent image.

U.S. Pat. No. 6,670,576 to Troitski et al. discloses a method for producing images containing laser-induced color centers and laser-induced damages. The method is based on two physical phenomenon: photoionization and laser-induced breakdown.

U.S. Pat. No. 6,768,080 to Troitski discloses a method for production of multi-color laser-induced damage images, which are looked like iridescent images laying out white light incident upon them.

The publication “Ways of creating color laser-induced images”(Troitski, in Proceeding of SPIE, Vol. 5273 (2003)) discusses deferent methods for creation of color laser-induced images inside transparent materials.

All U.S. Patents and publications mentioned above disclose methods and systems which use special transparent material (as photosensitive glass) or creation of special laser-induced etch points. Such images have constant color characteristics which are not changed during observation. Also the images do not change their image fragments. However, it is possible to create color laser-induced images by using special processing color images, creation of special arrangements of laser-induced damages inside a transparent material, and special illumination of this material. This way can provide production of both color laser-induced images and laser-induced images changing their colors and fragments during examination.

There are several U.S. Patents which disclose the systems and methods for creation of special damage arrangement.

U.S. Pat. No. 6,087,617 to Troitski et al. discloses a computer graphic system which creates arrangement of damages by optimal reducing pixels of the reproduced image.

U.S. Pat. No. 6,426,480 to Troitski discloses a method and laser system transforming an image into etch point arrangement for production of high quality single-layer laser-induced damage portraits inside transparent material. U.S. Pat. No. 6,605,797 to Troitski discloses a laser-computer graphics system transforming 3D image into arrangement of damages for producing images such as portraits and 3-D sculptures inside an optically transparent material.

U.S. Pat. No. 6,630,644 to Troitski et al. discloses a method creating damage arrangement for production of 3D laser-induced damage portraits inside transparent materials.

U.S. Pat. No. 6,720,523 to Troitski discloses a method for production of point arrangement for laser-induced images represented by incomplete data, which are supplemented during production.

U.S. Pat. No. 6,740,846 to Troitski, et al. discloses a method for creation point arrangement which provides production of 3D laser-induced head image inside transparent material by using several 2D portraits.

All these patents disclose methods and systems for transformation of image into arrangement of points so that, from one hand, breakdowns produced at these points do not create internal crash of the transparent material and from another hand, this damage arrangement reproduces high resolution images with correct gray shades. One of the purposes of this invention is the modernization of these point arrangements so that they preserve their characteristics mentioned above and simultaneously provide reproduction of colors and their changing during viewing. This invention disclose method and system for producing laser-induced images which are able to change their characteristics that is provided by combination of creating special point arrangement and special illumination of the transparent material.

### SUMMARY OF THE INVENTION

The principal task of the present invention is to provide a method for production of color laser-induced images which can change their characteristics.

One or more embodiments of the invention comprise a system for production of color laser-induced image by special processing of the original image and controlled illumination of the transparent material.

Another embodiment of the invention comprises a method for production of a color laser-induced image which changes its color characteristics during observation.

One or more embodiments of the invention comprise a method for production of a laser-induced image, the fragments of which can be changed during observation.

Another embodiment of the invention comprises a method for production of a laser-induced image so that illusion of their motion can be created during the observation.

One or more embodiments of the invention comprise a system for production of a laser-induced image, the color and the fragments of which can be changed during observation.

### DESCRIPTION OF THE DRAWINGS

FIG. 1 shows the combination of three damages (1, 2, 3) located inside three separated flat glasses illuminated by red (damage 1), green (damage 2) and blue (damage 3) light which together reproduce the correct color: FIG. 1a) shows a front view; FIG. 1b) is a left side view.

FIG. 2 shows the assembly of three separated transparent material sheets combined together for production of a color laser-induced damage image by using the RGB color model: beam 1 is focused at the glass sheet 1 for production of damages corresponding to the red color image, beam 2 is focused at the glass sheet 2 for production of damages corresponding to the green color image, beam 3 is focused at the glass sheet 3 for production of damages corresponding to the blue color image.

FIG. 3 shows the layer structure of laser-induced image inside the assembly of three separated transparent material sheets: red image located inside the first flat glass has three layers; green image located inside the second flat glass has four layers; blue image located inside the third glass has one layer.

FIG. 4 shows the color laser-induced image produced inside the assembly consisting of three glass plates: the first plate contains one damage layer, the second contains three damage layers, and the third contains two damage layers.

FIG. 5 shows the color laser-induced image produced inside the assembly consisting of three glass plates so that each layer contains one damage layer.

### DETAILED DESCRIPTION OF THE INVENTION

There are three colors of light—red, green, and blue—are known as the primary color (or the additive colors), which being combined produce white light and when they are mixed in varying intensities, they can form every other color. They are the colors that are used in video, and appear on a desktop color monitor.

Laser-induced image is a plurality of etch points (marks) inside a transparent material created by a pulsed laser beam, which is periodically focused at predetermined points of the material. The optical characteristics of a laser-induced image depend on the kind of etch points (laser-induced marks) used for its creation. It is possible to create marks, which are visible because they scatter the exterior light, but it is also possible to create marks, which are visible because they absorb the light. The first kind of the marks are created by laser-induced breakdowns, the second kind of marks (color centers) are arisen as a result of photo ionization. Images consisting of laser-induced damages produced by breakdowns are known as laser-induced damage images.

For creation of laser-induced images, which consist of marks scattering (reflecting) light, it is reasonable to use the RGB color model where colors are defined by specifying the intensity of the red, green, and blue components. For creation of laser-induced images, consisting of marks, which absorb light rather than reflect, it is reasonable to use the CMYK model, where the primary colors are blue, red, and yellow (or, more accurately, cyan, magenta, and yellow).

One or more embodiments of the invention comprise a differential method for reproduction of the real color by using a color model. In this case each pixel of an initial image is represented by one or several marks corresponding to the used color model. We explain the differential method by example of creation of laser-induced damages providing reproduction of the correct color by using the RGB color model.

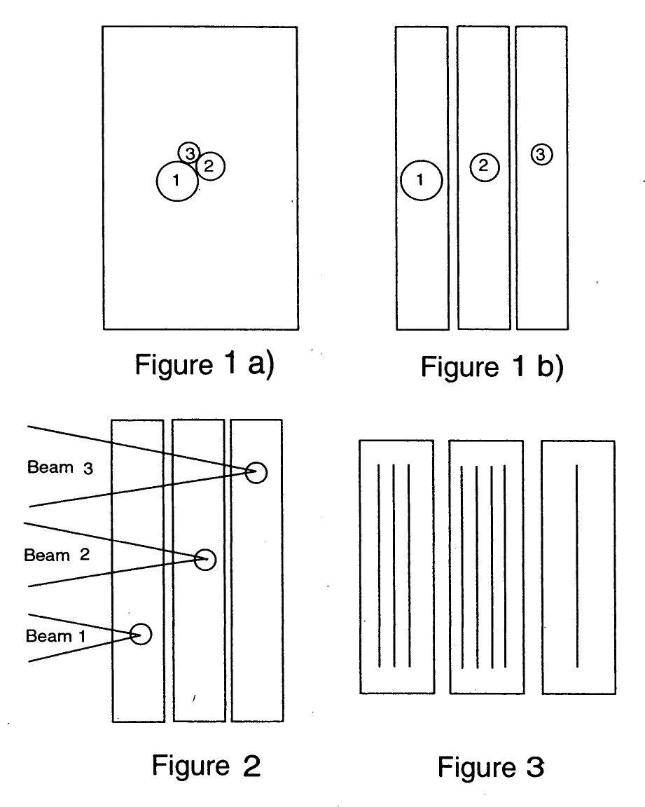

Let the pixels have a color which can be reproduced by a mix of the primary colors (red, green, and blue) and so that the intensity of red is larger than the intensity of green and the intensity of green is larger than the intensity of blue. In this case the pixel is reproduced inside a transparent material by three adjacent damages so that a damage, which scatters the red light, has larger sizes than other damages, and a damage scattering the green light has the sizes which are larger than the sizes of a damage, which scatters the blue light. The distances between these damages are larger than minimal critical distance, so that internal crash does not arise but distances between their projections into the observation plane are equal to zero. FIG. 1 illustrates an example of the location of such damages.

One or more embodiments of the invention comprise an integral method for reproduction of the color image inside a transparent material by using a color model. According to this method initial color image is represented as combination of one or several primary color images so that the superposition of these primary images provides the correct color of the initial image. For example, if the RGB color model is used, than the original image is represented by three primary images: red, green, and blue images. Every primary image is transferred into a single or multi-layers arrangement of points which provide reproduction of the primary image with high resolution without internal crash of the transparent material. The intensity value of the light, which should be reflected (scatter) by each point of the said arrangements is determined so that the correct brightness, saturation and hue could be created. The sizes and a shape of each laser-induced mark which is created at the predetermined point of the said arrangements are determined so that it reflects the light of the predetermined light intensity value.

The damage layers of each primary image are located inside the transparent material so that they can be illuminated by the light of the primary color. For creation of 2D laser-induced images, this condition can be satisfied simply if a transparent material is an assembly of several transparent sheets. Each sheet of the assembly contains the laser-induced marks corresponding to the same primary color. The laser-induced marks of each primary color image are produced inside the assembly sheet corresponding to this primary color. FIG. 2 illustrates the assembly of three separated transparent material sheets combined together for production of color laser-induced damage images by using the RGB color model: beam 1 is focused at the glass sheet 1 for production of damages corresponding to the red color image, beam 2 is focused at the glass sheet 2 for production of damages corresponding to the green color image, beam 3 is focused at the glass sheet 3 for production of damages corresponding to the blue color image. FIG. 3 shows the layer structure of laser-induced image inside the assembly of three separated transparent material sheets: red image located inside the first flat glass has three layers; green image located inside the second flat glass has four layers; blue image located inside the third glass has one layer.

One or more embodiments of the invention comprise a system for production of color laser-induced images inside a transparent material by special processing color image and multi-color illumination of the said transparent material. This system comprises three general subsystems: computer graphic system, a laser system, and an illumination system.

Computer graphic system provides processing of a color image in accordance with a color model. As a result of the processing, the system represents an initial color image as a superposition of several primary color images. This superposition depends on the optical characteristics of laser-induced marks: for laser-induced color images containing laser-induced damages, the superposition is created on the base of the RGB color model; for laser-induced color images consisting of absorbed laser-induced marks (as color centers), the superposition is created on the base of the CMYK color model.

After creation of primary color image superposition, the computer graphic system processes each primary color image. As a result of this processing, each primary color image is transformed into single or multi-layers point arrangements so that illuminated laser-induced damages, corresponding to the point arrangement, reproduce brightness, saturation, and hue of this primary color image. The correct reproduction of brightness, saturation, and hue of the primary color image is created by controlling the point density of each damage layer and sizes for every laser-induced damage. Necessary damage sizes and variation of point density are determined by the computer graphic system.

For color laser-induced images containing laser-induced damages, the computer graphic system determines the location of these laser-induced damages inside the transparent material so that the laser-induced damages corresponding to the primary color can be illuminated by the light of this primary color only.

A laser system provides the creation of laser-induced marks with the predetermined optical characteristics at the predetermined transparent material points. The laser-system comprises a laser, which generates pulsed radiation with parameters providing the creation of needed laser-induced marks at the transparent material. An apparatus controls an energy level of the laser for creating laser-induced marks of needed sizes. Also, the laser system includes apparatus for directing and focusing laser radiation at the each points of the predetermined point arrangement.

An illumination system generates light of all colors corresponding to the primary colors of used color model. The system illuminates laser-induced marks of all primary images so that laser-induced marks of the primary image are illuminated by the light of this primary color only. For example, if transparent material is an assembly of several separated transparent sheets and a color laser-induced damage image is produced in accordance with the RGB color model, then the sheets containing damages of the red primary image are illuminated by the red light only; the sheets containing damages of the green primary image are illuminated by the green light only; the sheets containing damages of the blue primary image are illuminated by the blue light only.

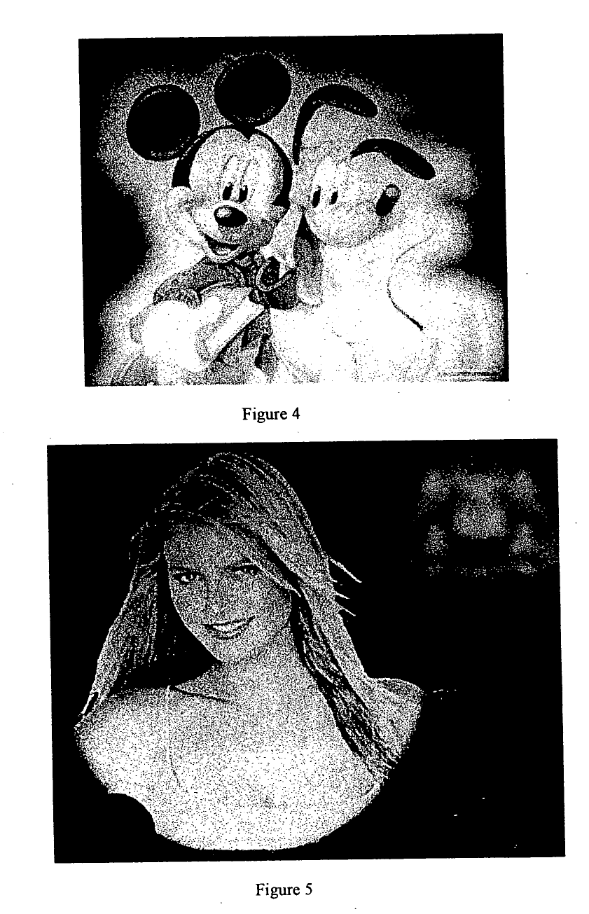

FIGS. 4 and 5 show the color laser-induced damage images produced inside the assembly consisting of three glass plates. The thickness of each glass plate is equal to 2 mm. FIG. 4 illustrates the color laser-induced damage image which is a superposition of three primary color images: red, green, and blue images. The damages of the red image are located inside the first glass plate and their point arrangement has one layer. The damages of the green image are located inside the second glass plate and their point arrangement has three layers. The damages of the blue image are located inside the third glass plate and their point arrangement contains two layers. FIG. 5 shows the color laser-induced damage image which is a superposition of three primary images (red, blue and green) but the point arrangement of each primary color image has one layer of damages.

One or more embodiments of the invention comprise a method for producing laser-induced images which are able to change their colors during observation. This effect is created by controlling hue and saturated colors of external light used for illumination of a transparent material. This control of external light is produced so that all damages corresponding to the primary color image is illuminated by the color of the same intensity, hue and saturation. For example, this way gives a chance to see landscape picture corresponding to the day, evening and night.

One or more embodiments of the invention comprise a method for producing laser-induced images which are able to change their fragments and create motion effects by the transformation of color image into special point arrangements and by controlling hue and saturated colors of external light used for illumination of a transparent material. In this case, image processing includes the separation of image fragments which change their characteristics during observation. These fragments are transformed into point arrangements apart from the rest of the image and the laser-induced damages corresponding to these arrangements are produced inside the transparent material so that they can be illuminated separately from other damages. For example, if a transparent material is an assembly of several transparent sheets, then laser-induced damages of the fragments which change their characteristics are produced inside their own separate sheet. Correct characteristics of the fragments are created by variation of intensity, hue and saturation of the color light illuminated damages of the fragment. It is important to note that when a part of damages is illuminated but another part is not, the damages of the last part are practically invisible. As a result of this effect, it is possible to create motion effect by switching on the illumination for the damages of a certain fragment and turn out the illumination for the damages of another fragment. In the mentioned above example of the landscape picture, it is possible to produce the stars and the moon which appear only in the evening and night time and their brightness is changed during observation. In this case laser-induced damages which reproduce the stars and the moon are produced inside their own transparent sheet illuminated by the color light with intensity changing during observation.

A method for producing laser-induced images, the fragments of which are able to change color, optical and visual characteristics as well as able to create motion effects by transforming color image into special point arrangements and by controlling hue and saturated colors of external light used for illumination of a transparent material, consists of the following steps:

Step 1. Separation of image fragments, which change their color, optical or other visual characteristics.

Step 2. Determination of the color model, which can be used for reproduction of color laser-induced image depending on the optical characteristics of the used laser-induced marks.

Step 3. Determination of the method (differential or integral) should be used for reproduction of the color laser-induced images.

Step 4. Transformation of the color image into superposition of several primary color images.

Step 5. Transformation of each said fragment into superposition of several primary color fragments.

Step 6. Transformation of each primary color image and each primary color fragment into single or multi-layer point arrangement so that laser-induced damages are produced inside the transparent material without internal crash.

Step 7. Determination of laser-induced damage density and sizes of each laser-induced damage so that color light reflected by the damages of corresponding to the point arrangement reproduce correct brightness, saturation, and hue of the primary color.

Step 9. Determination of location for the arrangement points inside the transparent material so that laser-induced marks generated at the said points can be illuminated by the light corresponding to the needed primary color.

Step 10. Generation of laser-induced marks at the predetermined points of the transparent material with predetermined sizes.

Step 11. Illumination of the laser-induced marks so that intensity and other light parameters can be controlled for each primary color image and for each primary color fragment separately.

A system, which produces such laser-induced images contains subsystem and apparatus as the system described above.

We claim:

1. A system for production of color laser-induced images inside a transparent material by special processing of color image and multi-color illuminating of the said transparent material, comprising:
Computer graphic system for processing of a color image in accordance with a color model, for determination of optical characteristics for each laser-induced mark, and for creation of location of the said marks inside the said transparent material so that the said marks provide reproduction of correct color image without an internal crash of the said transparent material;
Apparatus for creating laser-induced marks with the predetermined optical characteristics at the predetermined transparent material points;
Means for multi-color illumination of the said laser-induced damages so that parameters of the illuminated light is controlled.

2. The computer graphic system of claim 1, wherein color image processing for its production inside a transparent material is the transformation of the said color image into superposition of several primary color images.

3. The computer graphic system of claim 2 wherein the primary color image superposition provides the correct color production of the laser-induced images with needed optical characteristics of laser-induced marks, which form the said laser-induced images.

4. The computer graphic system of claim 2, wherein the RGB color model is used for transformation of a color image into several primary color images necessary for production of the laser-induced images containing laser-induced marks reflecting (scattering) the external light.

5. The computer graphic system of claim 2, wherein the CMYK color model is used for transformation of a color image into several primary color images necessary for production of laser-induced images containing laser-induced marks absorbing the external light.

6. The computer graphic system of claim 1, wherein each primary color image is transformed into a single or multi-layer point arrangement so that illuminated laser-induced damages, corresponding to the said point arrangement, reproduce brightness, saturation, and hue of this primary color image.

7. The computer graphic system of claim 6, wherein point arrangement reproducing correct brightness, saturation, and hue of a primary color laser-induced image is created by controlling point density and sizes of laser-induced damages.

8. The computer system of claim 1, wherein location of the points for each said primary color image is determined so that laser-induced marks generated at the said points of the transparent material can be illuminated by the light corresponding to the said primary color.

9. The transparent material of claim 1 is an assembly of transparent sheets, wherein the laser-induced marks corresponding to each primary color image are produced inside their sheet of the said assembly.

10. The apparatus in accordance with claim 1, wherein the pulsed laser generates pulsed radiation with parameters which provide the creation of needed laser-induced marks at the transparent material points of the said arrangements.

11. The apparatus of claim 4, wherein pulsed radiation energy is controlled so that laser-induced marks have sizes needed for reproduction of corrected brightness, saturation, and hue.

12. The apparatus of claim 1, wherein laser radiation is directed and focused at each transparent material point of the said point arrangements.

13. The apparatus of claim 1, wherein laser radiation is directed and focused at each transparent material sheets of the said assembly.

14. Method for producing of laser-induced images which are able to change their colors during observation by controlling intensity, hue and saturated colors of external light which illuminates the damages that reproduce the same primary color image.

15. Method for producing laser-induced image, the fragments of which are able to change their color, optical and other visual characteristics as well as able to create motion effects by transforming of color image into special point arrangements and by controlling hue and saturated colors of external light used for illumination of laser-induced images comprising:
processing a color image and generating point arrangements so that they consist of points corresponding to both initial color image and its fragments which change their color, optical and visual characteristics;
locating points of the said point arrangements inside the said transparent materials so that the control of the light illuminated laser-induced damages produced at the points can be produced for the image and its fragments separately;
generating laser-induced marks at the predetermined transparent material points with needed characteristics so that internal crash does not arise;
illuminating laser-induced damages corresponding to the all point arrangements so that needed image fragments change their color and other needed optical characteristics.

16. The method of claim 15, wherein image processing consists of the following steps:
Step 1. Separation of image fragments, which change their color, optical or other visual characteristics.
Step 2. Determination of the color model, which can be used for reproduction of color laser-induced image depending on the optical characteristics of the used laser-induced marks.
Step 3. Determination of the method (differential or integral) should be used for reproduction of the color laser-induced images.
Step 4. Transformation of the color image into superposition of several primary color images.
Step 5. Transformation of each said fragment into superposition of several primary color fragments.
Step 6. Transformation of each primary color image and each primary color fragment into single or multi-layer point arrangement so that laser-induced damages are produced inside the transparent material without internal crash.
Step 7. Determination of laser-induced damage density and sizes of each laser-induced damage so that color light reflected by the damages of corresponding to the point arrangement reproduce correct brightness, saturation, and hue of the primary color.
Step 9. Determination of location for the arrangement points inside the transparent material so that laser-induced marks generated at the said points can be illuminated by the light corresponding to the needed primary color.
Step 10. Generation of laser-induced marks at the predetermined points of the transparent material with predetermined sizes.
Step 11. Illumination of the laser-induced marks so that intensity and other light parameters can be controlled for each primary color image and for each primary color fragment separately.

17. The differential method of claim 16, wherein reproduction of needed color for each pixel is provided by the combination of several laser-induced marks with predetermined optical characteristics.

18. The integral method of claim 16, wherein reproduction of a color image is provided by superposition of primary color images with controlling damage density and sizes of each laser-induced damage corresponding to each primary color image.
